(19) United States
(12) Patent Application Publication
(10) Pub. No.: US 2008/0264655 A1
(43) Pub. Date: Oct. 30, 2008

(54) Combination garden tool

(76) Inventor: Joseph Lane Knowlden, Mesa, AZ (US)

Correspondence Address: JOSEPH L. KNOWLDEN, 4235 N. STARRY PASS, MESA, AZ, 85207, US

(21) Appl. No.: 11/803,291

(22) Filed: Apr. 30, 2007

(51) Int. Cl. A01B 1/00

(52) U.S. Cl. 172/378

(57) ABSTRACT

A combination gardening tool that will perform as a cultivator, weeder, and hoe. The present invention has an elongated handle and a cultivator head at one end. The cultivator head is comprised of a row of cultivator tines and a cutting blade. The cultivator tines are of substantially equal lengths and extend substantially parallel to each other and have sharpened ends. The cutting blade is located substantially near the sharpened ends of the cultivator tines. The cultivator tines loosen and break up the soil and the cutting blade slices the ground to sever weeds and vegetation. The cutting blade also performs as a conventional hoe which is used to hack, chop and remove unwanted foliage and vegetation. In addition the width of the cutting blade is sufficient enough to effectively move soil, make garden rows, make furrows, and level the ground surface working area.

### CROSS-REFERENCE TO RELATED APPLICATIONS

Not Applicable

### BACKGROUND OF THE INVENTION

This invention relates to combination gardening tools, more specifically, wherein the device is used for cultivating, weeding and hoeing.

One of the most time consuming and trying parts of gardening is having the proper tool for the tasks to be performed. The user would normally have to gather up a cultivator, hoe and a weeding device and carry it out to the working area. When the user would move to different areas the garden tools would have to be carried along or retrieved from the previous location. This required a lot of effort and was time consuming and very frustrating on the part of the user.

In response to these problems various combination gardening tools were designed to perform a variety of cultivating, weeding and hoeing tasks. U.S. Pat. No. 1,187,876 to Wester (1916) and U.S. Pat. No. 3,921,725 to Trutor (1975) show cultivators equipped with hoe blades. Both of these devices require turning the handle position to move from cultivating to hoeing tasks. They are not balanced and have poor handling characteristics that tend to twist in the hands of the user. In addition each of these devices do not incorporate a cutting blade to slice the ground for severing weeds and vegetation. U.S. Pat. No. 5,003,760 to Webb (1991) shows a combination cultivator, rake and hoe. This design has considerable drag in the cultivator position and requires turning the handle position to use the rake function. It also does not have a cutting blade to slice the ground and effectively remove weeds and vegetation.

U.S. Pat. No. 5,477,667 to Bryant (1995) shows a combination gardening implement with cultivator tines with a rod for removing weeds. It also has a blade attachment for slicing the ground for weeding, but requires rotating the handle position to use it. This design is awkward and not well balanced and would tent to twist in the hands of the user. In addition the rod portion of the device would cause excessive drag when attempting to slice the ground. It simply would not sever weeds, foliage and vegetation effectively. U.S. Pat. No. 2,780,976 to Koering (1957) shows a garden tool with cultivator tines and a cutting blade attachment. The cutting blade attachment is adjustably mounted to threaded end tines. This design does not effectively secure the cutting blade to the tines and would be quickly be compromised and rendered useless. The threaded tines used for adjusting the position of the cutting blade attachment would be easily damaged and non-functional when making contact with any hard surface such as soil, rocks, gravel, cement or brick landscaping. In addition the combined drag of the blade sleeve elements, deformed trough-like features and end nuts that hold the cutting blade attachment to the tines would not allow for a effective streamline ground slicing action.

U.S. Pat. No. 4,915,179 to Hawk (1990) shows a combination cultivator and weeder blade. This design requires rotating the handle position back and forth to perform the desired task of cultivating or weeding. Another drawback of this design is the weeder blade is not effective as a hoe blade for making garden furrows, rows and moving soil.

All combination garden tools heretofore known suffer from a number of disadvantages:
(a) They do not have the ability to cultivate, hoe and effectively slice the ground for weeding without rotating the handle position.
(b) The garden tool is bulky, clumsy and not well balanced causing more effort for the user.
(c) None offer all of the benefits of cultivating, hoeing and weeding in one well balanced effort reducing durable gardening tool.
(d) They have attachments that have to be added and removed for the different gardening tasks the user is trying to accomplish.

### BRIEF SUMMARY OF THE INVENTION

This invention is a combination gardening tool that will perform as a cultivator, weeder, and hoe. The present invention has an elongated handle and a cultivator head attached at one end. The cultivator head is comprised of cultivator tines and which incorporates a cutting blade that will slice the ground to sever weeds and foliage. In addition, the cutting blade also functions as a conventional hoe which is used to hack and chop the ground and which will also effectively move soil.

The above mentioned functions are accomplished by the placement of the cutting blade substantially near the sharpened ends of the cultivator tines. The present invention is comprised of an integral head design made from one piece of durable metal or whereby the cutting blade is welded or brazed to the cultivator tines.

The advantage of this invention is to provide a combination gardening tool that is durable and will remain functional under heavy use when in contact with hard soil, gravel, rocks, and around cement landscape borders.

Several objects and advantages of the present invention are:
(a) To provide the ability to cultivate, hoe and slice weeds and foliage in one combination gardening tool.
(b) To provide a gardening tool which is durable that will remain functional under heavy use in hard soil, gravel, rocks, and around cement landscape borders.
(c) To provide the operator the ability to cultivate, hoe and sever weeds without having to turn or rotate the handle position.
(d) To provide a low effort, weed slicing operation and cultivate the soil in one motion.
(e) To provide more depth control of the cultivator tines. The cutting blade will tend to keep the tines from digging into the soil for light cultivation and around landscape plants and shrubs that have surface roots.

### BRIEF DESCRIPTION OF THE DRAWINGS

A more complete understanding of the invention will be better understood by reference to the accompanying drawings of which:

FIG. 1 is a side elevation view of the combination garden tool.

FIG. 2 is a perspective view of the preferred embodiment of the combination garden tool.

FIG. 3 is a front elevation view of the combination garden tool.

FIG. 4 is a rear elevation view of the combination garden tool.

By reference to the drawings, numeral 1 is the elongated handle and the handle sleeve is designated by numeral 2. The cutting blade is designated by numeral 3. The cultivator tines are designated by numeral 4. The cultivator head is designated by numeral 5.

### DETAILED DESCRIPTION OF THE INVENTION

The present invention as shown in the accompanying drawings is a combination gardening tool. As will be more fully described herein, this invention is a combination gardening tool that will perform as a cultivator, weeder and a hoe.

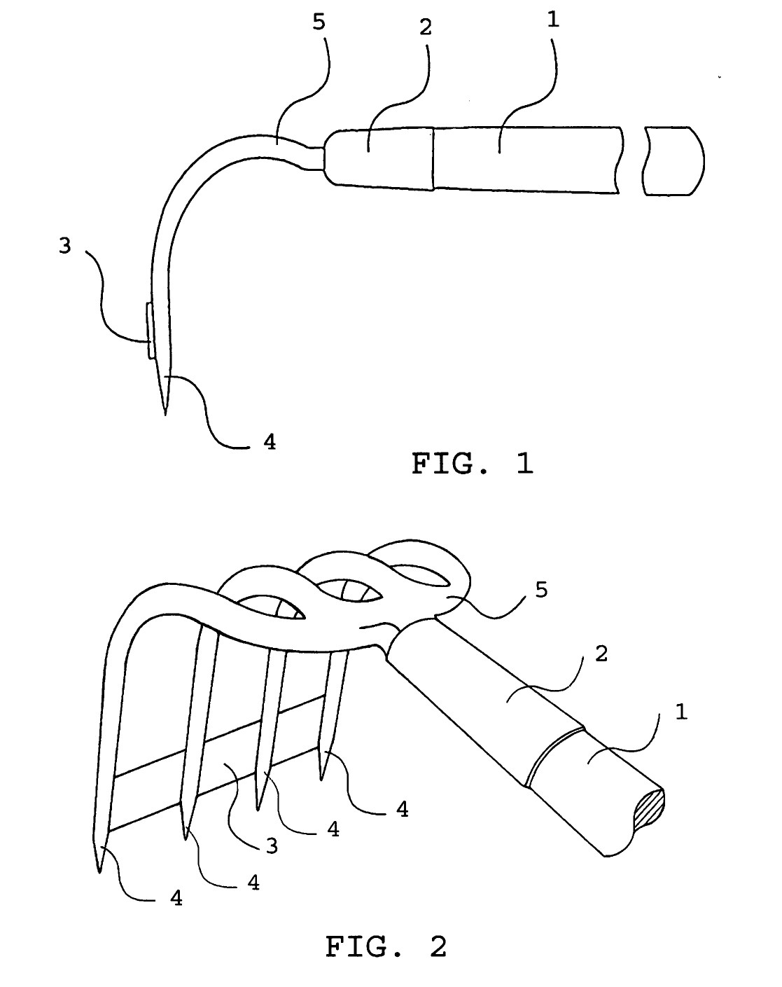

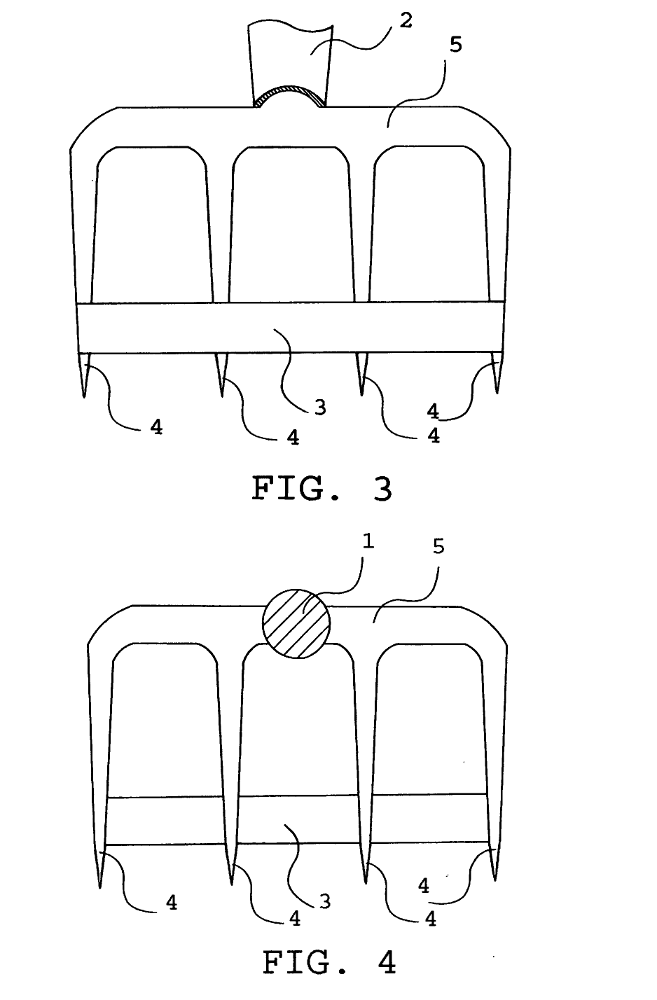

The preferred embodiment of the present invention is illustrated in FIG. 2. Referring to FIG. 2, the fore shortened elongated handle 1 with sleeve 2 is connected to the cultivator head 5. The cultivator tines 4 with substantially equal lengths and sharpened ends are disposed in a row extending substantially parallel to each other with the cutting blade 3 located substantially near the sharpened ends of the cultivator tines 4.

With reference to FIGS. 1 and 2, the cultivator tines 4 perform as conventional cultivator tines to loosen and break up the soil with the enhanced capability to control the depth of soil penetration. The ability to control the depth of soil penetration is provided by the cutting blade 3 which is located substantially near the sharpened end of the cultivator tines 4. When the elongated handle 1 is positioned more parallel to the ground and the cultivator head 5 is moved back and forth in the ground the cutting blade 3 will act as a depth governor. When the cutting blade 3 makes contact with the ground it will tend to inhibit the cultivator tines 4 digging into the ground as a conventional cultivator will.

This is especially beneficial when the user is cultivating around surface roots. The cutting blade 3 will contact the surface roots just below the ground surface and slide over the roots thereby inhibiting the cultivator tines 4 to penetrate deeper in the ground. In addition if the user desires to penetrate the ground deeper all that is required is additional downward pressure on elongated handle 1.

When the user encounters surface roots or vegetation that are to large to penetrate by applying more downward pressure on the elongated handle 1 they can use the cutting blade 3 as a conventional hoe to chop and hack the ground to remove them if desired. This allows the user to selectively cultivate around shrubs and plants with minimum soil disturbance or remove larger unwanted roots and vegetation when desired.

The cutting blade 3 can also be used to slice the ground to sever weeds and vegetation. When the elongated handle 1 is positioned more perpendicular the ground the cutting blade 3 will be almost parallel to the ground. In this position the cutting blade 3 will slice the ground in a streamline manner requiring very low effort on the part of the user. The cutting blade 3 will make initial contact with the ground thereby effectively eliminating any drag from the cultivator tines 4.

When the elongated handle 1 is positioned more parallel to the ground the cutting blade 3 will be more perpendicular to the ground. In this position the cutting blade 3 will perform like a conventional hoe to chop and hack weeds and remove vegetation. In addition the cutting blade 3 has enough surface area to effectively make garden furrows, rows, move soil and level the ground surface area.

With reference to FIG. 2, the preferred embodiment of the present invention is a one piece integral cultivator head 5 design constructed from one piece of durable metal. Another embodiment of the invention would be whereby the cutting blade 3, made of durable metal is welded, brazed or metal fused to the cultivator tines 4.

Although the description above contains the essential characteristics of this invention, these should not be construed as limiting the scope of the invention but as merely providing illustrations of some of the presently preferred embodiments of this invention. For example one could easily shorten the length of elongated handle 1 or modify the shape of the cultivator tines 4 or the cutting blade 3 location and width. Therefore the scope of the invention should be determined by the appended claims and their legal equivalents rather the examples given.

What is claimed is:

1. A combination gardening tool with an elongated handle and a cultivator head attached to one end of said elongated handle comprising:
an elongated handle extending longitudinally and a integral cultivator head made from one piece of durable metal with a row of cultivator tines and a cutting blade; said cultivator tines with substantially equal lengths and sharpened ends are substantially parallel to each other and generally inclined to the axis of said elongated handle;
said cutting blade is substantially located near the sharpened ends of said cultivator tines, and positioned in front of said cultivator tines, whereby the flat width portion of said cutting blade is perpendicular to said cultivator tines and extends across all of said cultivator tines.

2. A combination gardening tool as claimed in claim 1 wherein said cutting blade is positioned in back of said cultivator tines.

3. A combination gardening tool as claimed in claim 1 wherein the cultivator head is connected to a shortened handle.

4. A combination gardening tool with an elongated handle and a cultivator head attached to one end of said elongated handle comprising:
an elongated handle extending longitudinally and a cultivator head with a row of cultivator tines and a cutting blade; said cultivator tines with substantially equal lengths and sharpened ends are substantially parallel to each other and generally inclined to the axis of the handle; said cutting blade is substantially located near the sharpened ends of said cultivator tines, and positioned in front of said cultivator tines, whereby the flat width portion of said cutting blade is perpendicular to said cultivator tines and extends across all of said cultivator tines; wherein said cutting blade is permanently connected to said cultivator tines by being welded together.

5. A combination gardening tool as claimed in claim 4 wherein said cutting blade is permanently connected to said cultivator tines by being brazed together.

6. A combination gardening tool as claimed in claim 4 wherein said cutting blade is permanently connected to said cultivator tines by being metal fused together.

7. A combination gardening tool as claimed in claim 4 wherein said cutting blade is positioned in back of said cultivator tines.

8. A combination gardening tool as claimed in claim 4 wherein said cultivator head is connected to a shortened handle.
